(19) United States
(12) Patent Application Publication
(10) Pub. No.: US 2009/0172890 A1
(43) Pub. Date: Jul. 9, 2009

(54) Method for Producing Leather

(75) Inventors: Stephan Huffer, Ludwigshafen (DE); Stefan Schroeder, Shanghai (CN); Philippe Lamalle, Lambsheim (DE); Volker Bach, Neustadt (DE)

Correspondence Address: Connolly Bove Lodge & Hutz LLP, 1875 Eye Street, NW, Washington, DC, 20006, US

(73) Assignee: Basf Aktiengesellschaft Patents, Trademarks and Licenses, Ludwigshafen (DE)

(21) Appl. No.: 11/995,511

(22) PCT Filed: Jul. 6, 2006
(86) PCT No.: PCT/EP2006/063956

§ 371 Date: Jan. 11, 2008

(30) Foreign Application Priority Data
Jul. 11, 2005 (DE) 10 2005 032 585.8

(51) Int. Cl. C14C 1/08

(52) U.S. Cl. 8/94.17

(57) ABSTRACT

Process for the production of leather, wherein, after liming, deliming and, if appropriate, pickling, animal hides are pretanned or tanned with a mixture of compounds comprising

(a) at least one organic tanning agent and
(b) a mixture of
(b1) at least one C₃-C₁₂-dicarboxylic acid
(b2) and at least one further acidic compound selected from C₁-C₃-mono- or C₃-C₁₂-dicarboxylic acids, or salts thereof.

The present invention relates to a process for the production of leather, wherein, after liming, deliming and, if appropriate, pickling, animal hides are treated with
(a) at least one organic tanning agent and
(b) a mixture of
(b1) at least one C₃-C₁₂-dicarboxylic acid
(b2) and at least one further acidic compound selected from C₁-C₃-mono- or C₃-C₁₂-dicarboxylic acids or salts thereof.

The present invention furthermore relates to formulations comprising
(a) at least one organic tanning agent and
(b) a mixture of
(b1) at least one C₃-C₁₂-dicarboxylic acid
(b2) and at least one further acidic compound selected from C₁-C₃-mono- or C₃-C₁₂-dicarboxylic acids or salts thereof.

The present invention furthermore relates to leathers produced according to the invention.

In tanning, a distinction is made between chrome tanning and chromium-free tanning, which leads to wet blue or wet white semifinished products. Chromium-free tanning has certain ecological advantages: no chromium-containing wastewaters form and the shaving wastes are likewise chromium-free and do not have to be disposed of specially.

Important tanning agents for chromium-free tanning are, for example, polymers and aldehydes, in particular dialdehydes, such as, for example, glutaraldehyde. If it is desired to produce wet white semifinished products, it is observed in many cases that, instead of the desired white semifinished products, yellowish products are obtained with the use of aldehydes, in particular dialdehydes, such as, for example, glutaraldehyde. Furthermore, in some cases, the semifinished products obtained are difficult to same or difficult to shave. These problems are observed in particular with the use of hard water, for example with 20° dH or more. These problems are also observed when the pelts have not been completely delimed. In the context of the present invention, deliming is understood as meaning the step of removing basic substances used during liming from the pelt, in particular CaO/Ca(OH)₂.

It is possible to pretreat the water used for tanning, for example with the aid of an ion exchanger, and thus to reduce the hardness. However, such a procedure is expensive and is not feasible.

It was therefore the object to provide a process for the production of leather, by means of which white semifinished products which have no yellow tinge are obtained in the chromium-free tanning and in particular in the tanning with aldehydes, very particularly dialdehydes, such as, for example, glutaraldehyde, independently of the choice of the deliming method and of the quality (completeness) of the deliming. It was furthermore the object to provide formulations which are suitable for the chromium-free production of leather, in particular for tanning with aldehydes, and avoid the abovementioned disadvantages. It was furthermore the object to provide leather having little tendency to exhibit a yellow tinge.

Accordingly, the process defined at the outset was found.

In the context of the present invention, pretanned or tanned animal hides for which retanning is still required are referred to as semifinished products. In the context of the present invention, retanned semifinished products and completely tanned animal hides for which no further retanning is required are referred to as leather.

The process according to the invention starts from animal hides which may be obtained from any desired dead animals, in particular from cattle hides, calf hides, goat hides, deer hides or pig hides.

The process according to the invention starts from animal hides which have been limed and delimed by any desired method, i.e. freed from excess CaO and Ca(OH)₂ or other basic substances, such as, for example, NaOH. Animal hides used for carrying out the process according to the invention may furthermore have been pickled, i.e. pretreated after the deliming with formic acid or acetic acid.

An embodiment of the present invention starts from animal hides which are delimed using boric acid, for example using mixtures of boric acid and C₁-C₃-carboxylic acid or using mixtures of boric acid and C₁-C₃-carboxylic acid and alkali metal sulfite. Another embodiment of the present invention starts from animal hides which have been delimed using one or more ammonium salts, in particular using mixtures of ammonium chloride and ammonium sulfate. Another embodiment of the present invention starts from animal hides which have been delimed using CO₂ or one or more organic compounds which can eliminate CO₂ in an aqueous medium, in particular using one or more organic carbonates, in particular using mixtures of ethylene carbonate and propylene carbonate.

The following are used for carrying out the process according to the invention:
(a) at least one organic tanning agent, in particular at least one organic tanning agent which is selected from aldehydes, dialdehydes and compounds which can eliminate formaldehyde, acetaldehyde or dialdehydes at acidic pH, in particular in an aqueous medium at a pH in the range from 1.5 to 6.5. Preferred aldehydes are formaldehyde, acetaldehyde and glyoxalic acid. Preferred dialdehydes are glyoxal and compounds of the general formula OHC—(CH₂)ₓ—CHO, where x may be an integer in the range from 1 to 10, preferably from 2 to 7 and very particularly preferably 3 or 4. The compound of the formula OHC—(CH₂)₃—CHO corresponds to glutaraldehyde.

Preferred compounds which can eliminate formaldehyde or dialdehydes, in particular in an aqueous medium at a pH in the range from 1.5 to 6.5, are, for example, dimers, trimers, polymers, hydrates, dihydrates, acetals, hemiacetals and acylals of formaldehyde, acetaldehyde or dialdehydes. The following may be mentioned as examples:

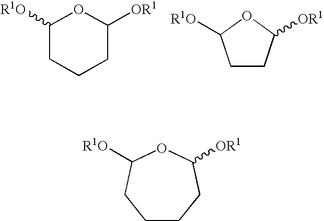

where each R¹ may be the same or different and is selected from C₁-C₁₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, preferably C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl, such as methyl, ethyl, n-propyl, isopropyl, n-butyl, isobutyl, sec-butyl and tert-butyl, and very particularly preferably methyl,
C₁-C₃-acyl, for example formyl, acetyl or propionyl,
and in particular hydrogen.

Further suitable compounds which can eliminate dialdehydes at acidic pH are disclosed, for example, in WO 03/95681 and WO 04/67782.

Further suitable compounds which can eliminate dialdehydes at acidic pH are bisoxazolidinones derived from, for example, OHC—(CH₂)ₓ—CHO.

Further suitable compounds which can eliminate formaldehyde or acetaldehyde at acidic pH are tetrakishydroxymethylphosphonium salts and tetrakishydroxyethylphosphonium salts, in particular tetrakishydroxymethylphosphonium chloride.

Organic tanning agent (a) is very particularly preferably selected from glutaraldehyde, for example as the cyclic dihydrate

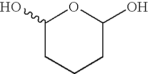

or as the dimethyl acetal

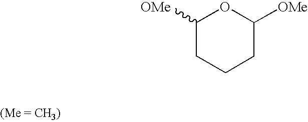

Furthermore, animal hides are treated with a mixture (b) of

(b1) at least one-C₃-C₁₂-dicarboxylic acid, preferably at least one olefinically unsaturated C₄-C₁₂-dicarboxylic acid or particularly preferably at least one aliphatic C₃-C₁₂-dicarboxylic acid, for example malonic acid, methylmalonic acid, maleic acid, fumaric acid, succinic acid, citraconic acid, metaconic acid, glutaric acid, itaconic acid, adipic acid, sebacic acid, pimelic acid, phthalic acid, terephthalic acid and isophthalic acid, in particular succinic acid, glutaric acid and adipic acid,
(b2) at least one further acidic compound selected from C₁-C₃-monocarboxylic acids, such as formic acid, acetic acid or propionic acid, C₃-C₁₂-dicarboxylic acids, for example phthalic acid, terephthalic acid or isophthalic acid, preferably olefinically unsaturated C₄-C₁₂-dicarboxylic acids or particularly preferably aliphatic C₃-C₁₁ dicarboxylic acids, for example malonic acid, methylmalonic acid, maleic acid, fumaric acid, succinic acid, citraconic acid, metaconic acid, glutaric acid, itaconic acid, adipic acid, sebacic acid and pimelic acid, in particular succinic acid, glutaric acid and adipic acid.

If further acidic compound (b2) is selected from C₃-C₁₂-dicarboxylic acids, the C₃-C₁₂-dicarboxylic acid (b2) is of course not the same as the C₃-C₁₂-dicarboxylic acid (b1).

C₃-C₁₂-Dicarboxylic acids (b1) and/or further acidic compound (b2) selected from C₃-C₁₂-dicarboxylic acids and C₁-C₃-monocarboxylic acids, can in each case be used as free acid or in the form of salts thereof. For example, alkali metal salts, such as sodium or potassium salts may be mentioned as salts. In principle, salts of amines, such as, for example, H_{1-y}(R²)_{y}, are furthermore suitable.

R² in each case are identical or different and, independently of one another, are selected from C₁-C₄-alkyl, such as methyl, ethyl, n-propyl, isopropyl, n-butyl, isobutyl, sec-butyl and tert-butyl and very particularly preferably methyl or ethyl, and ω-hydroxy-C₂-C₄-alkylene, such as, for example, 3-hydroxypropyl, 4-hydroxybutyl and in particular 2-hydroxyethyl.

In an embodiment of the present invention, C₃-C₁₂-dicarboxylic acids (b1) used and/or further acidic compound (b2), selected from C₃-C₁₂-dicarboxylic acids and C₁-C₃-monocarboxylic acids, are partly neutralized.

In an embodiment of the present invention, treatment is effected with a mixture comprising two different C₃-C₁₂-dicarboxylic acids and a C₁-C₃-monocarboxylic acid.

In an embodiment of the present invention, adipic acid, as the C₃-C₁₂-dicarboxylic acid (b1) and two further acidic compounds (b2), in particular a C₃-C₁₂-dicarboxylic acid and a C₁-C₃-monocarboxylic acid, are selected.

In an embodiment of the present invention, adipic acid, as the C₃-C₁₂-dicarboxylic acid (b1), and two further acidic compounds (b2), in particular two C₃-C₁₂-dicarboxylic acids, preferably glutaric acid and succinic acid, are selected.

The process according to the invention is preferably carried out in aqueous liquor. For example, drums, preferably rotatable drums, and in particular rotatable drums having baffles, may be mentioned as suitable apparatuses.

In an embodiment of the present invention, organic tanning agent (a) and mixture (b) are used in a weight ratio of from 100:1 to 1:1, preferably from 5:1 to 1.5:1.

In an embodiment of the present invention, animal hide is treated with from 0.1 to 10% by weight of tanning agent (a), based on the shaved weight, preferably from 1.5 to 5% by weight.

In an embodiment of the present invention, the process according to the invention is carried out at a temperature in the range from 15 to 50° C., preferably from 20 to 35° C.

In an embodiment of the present invention, a pH in the range from 2.0 to 6.5, preferably from 2.8 to 5.0, is established for carrying out the process according to the invention.

In an embodiment of the present invention, the process according to the invention is carried out over a period of from 5 minutes to 24 hours, preferably from 60 minutes to 6 hours.

The process according to the invention can be carried out using soft water, for example water of from 0 to 7° dH (German hardness). In a particular embodiment of the present invention, the process according to the invention is carried out using medium-hard water, for example water of from 7 to 19° dH, preferably with hard water or at least 20 to 200° dH.

In an embodiment of the present invention, one or more leather dyes are added while the process according to the invention is being carried out. In another embodiment, the process according to the invention is carried out without addition of leather dyes.

In an embodiment of the present invention, one or more further chromium-free tanning agents are added while the process according to the invention is being carried out, for example mineral tanning agents, for example, aluminum compounds, in particular aluminum sulfate or alum, zirconium compounds, such as, for example, Zr(SO₄)₂ or ZrSO₄(OH)₂ or titanium compounds, such as, for example, Ti(SO₄)₂ or TiSO₄(OH)₂, resin tanning agents, vegetable tanning agents or enzymatic tanning agents or synthetic tanning agents, such as, for example, condensates of carbonyl compounds, such as, for example, formaldehyde, with one or more aromatic sulfonic acids. Furthermore, one or more dispersants may be added, in particular one or more nonionic surfactants, for example polyethoxylated aliphatic C₆-C₂₀-alcohols, branched or straight-chain.

In an embodiment of the present invention, the process according to the invention is carried out as pretanning or as tanning.

For carrying out the process according to the invention, organic tanning agent (a) and mixture (b) can be metered separately or preferably together.

In a special embodiment of the present invention, the process according to the invention is carried out as retanning, for example at a pH in the range from 3 to 6 and a temperature in the range from 20 to 65° C.

In a special variant of the present invention, the process according to the invention is carried out in such a way that, during the pickling, treatment is effected with
(a) at least one organic tanning agent and
(b) a mixture of
(b1) at least one C₃-C₁₂-dicarboxylic acid
(b2) and at least one further acidic compound selected from C₁-C₃-mono- or C₃-C₁₂-dicarboxylic acids, or salts thereof.

The last-mentioned variant of the present invention is carried out starting from pelts.

For carrying out the last-mentioned variant of the present invention, one or more alkali metal halides, in particular sodium chloride, may be added, for example from 1 to 10% by weight, based on the pelt, preferably from 4 to 7% by weight. However, alkali metal halide can be completely or proportionately replaced by ionic polymers.

The residence time of the pelts in the pickle in the last-mentioned variant of the present invention is, for example, from 10 minutes to 24 hours, preferably from 15 minutes to 2 hours and particularly preferably from 15 to 45 minutes.

The pickling in the last-mentioned variant of the present invention takes place under conditions otherwise customary in tanning; the temperature is from 10 to 35° C. and the pressure is from 1 to 10 bar, atmospheric pressure being particularly expedient.

After one or more of the above-described steps of the process according to the invention has been carried out, retanning, for example using one or more synthetic tanning agents, resin tanning agents or vegetable tanning agents or mixtures of the abovementioned retanning, agents, and furthermore fatliquoring, hydrophobing and working-up can be effected by methods known per se.

Semifinished products and leather produced by the process according to the invention are distinguished, even with the use of hard water, by particularly good whiteness, good fullness and softness and particularly little tendency to yellowing and are particularly suitable for the production of articles of clothing, such as, for example, coats, jackets, belts, shoes and gloves, and furthermore pieces of furniture and interior automotive parts. Furthermore, semifinished products produced by the process according to the invention have good to very good shaveability and good to very good samming behavior and can be very readily processed to give leather.

The present invention furthermore relates to formulations, in particular aqueous formulations, comprising
(a) at least one organic tanning agent and
(b) a mixture of
(b1) at least one C₃-C₁₂-dicarboxylic acid
(b2) and at least one further acidic compound selected from C₁-C₃-mono- or C₃-C₁₂-dicarboxylic acids, or salts thereof.

Organic tanning agent (a) and mixture (b) are as defined above.

In an embodiment of the present invention, organic tanning agents (a) are selected from aldehydes, dialdehydes and compounds which can eliminate formaldehyde, acetaldehyde or dialdehydes at an acidic pH in the presence of water. Glutaraldehyde, is very particularly preferably selected as tanning agent (a).

In an embodiment of the present invention, mixture (b) comprises at least two C₃-C₁₂-dicarboxylic acids selected from adipic acid, glutaric acid, maleic acid and succinic acid, or salts thereof.

Formulations according to the invention may comprise, for example, in the range of from 30 to 80% by weight of water.

Formulations according to the invention can preferably have a pH in the range from 2.5 to 6.5, particularly preferably in the range from 3.0 to 5.0.

Formulations according to the invention may comprise, for example,

altogether in the range of from 10 to 70% by weight of organic tanning agent (a), preferably from 15 to 40% by weight,
in the range of from 2.5 to 50% by weight of mixture (b), preferably from 5 to 25% by weight,
data in % by weight being based on the total formulation according to the invention and the remainder being, for example, water.

Mixture (b) present in the formulation according to the invention may comprise, for example,

altogether in the range of from 30 to 99% by weight of C₃-C₁₂-dicarboxylic acid (b1), altogether in the range of from 1 to 70% by weight of further acidic compound (b2), data in % by weight being based on mixture (b).

Formulations according to the invention are particularly suitable for carrying out the above-described process according to the invention.

The present invention furthermore relates to the use of the formulations according to the invention for the production of leather, for example for pretanning, tanning or retanning or in the pickle. The present invention furthermore relates to a process for the production of leather, for example a process for pretanning, tanning or retanning or for pickling, using the formulation according to the invention. Pretanning and tanning are particularly preferred. However, the formulation according to the invention can also be used especially in the pickle.

The present invention furthermore relates to semifinished products and leather, produced by the process according to the invention. Leathers according to the invention are distinguished, even with the use of hard water, by good whiteness, good fullness and softness and a particularly little tendency to yellowing and are particularly suitable for the production of articles of apparel, such as, for example, coats, jackets, belts, shoes, in particular lining and upper leather, and gloves, and furthermore pieces of furniture and interior automotive parts. Furthermore, semifinished products produced by the process according to the invention have good to very good shaveability and good to very good samming behavior and can be very readily processed to give leather.

The present invention furthermore relates to a process for the preparation of formulations according to the invention, also referred to below as preparation process according to the invention. For carrying out the preparation process according to the invention, for example, first a mixture (b) of at least one C₃-C₁₂-dicarboxylic acid (b1) and at least one further acidic compound (b2), selected from C₁-C₃-mono- or C₃-C₁₂-dicarboxylic acids, is prepared in water and, if appropriate, partly or completely neutralized with a base, such as, for example, basic alkali metal salt, for example potassium or sodium salts, such as carbonates or bicarbonates, in particular sodium hydroxide, or with ammonia or an organic amine, and then at least one organic tanning agent (a) is admixed.

The invention is explained by working examples.

### I. Preparation of Formulations According to the Invention

### I.1 Preparation of Formulation F-1 According to the Invention

18 g (123 mmol) of adipic acid (b1-1), 12 g (102 mmol) of succinic acid (b2-1) and 3 g (65 mmol) of concentrated formic acid (b2-2) and 210 ml of distilled water were mixed with one another in a stirred vessel. 8 g of a 50% strength by weight aqueous sodium hydroxide solution (corresponding to 100 mmol of NaOH) were added. 240 g of a 50% by weight aqueous solution of glutaraldehyde (a-1) were then metered in with stirring. Aqueous formulation F-1 according to the invention was obtained. Aqueous formulation F-1 according to the invention had a pH of from 3 to 4.

### I.2 Preparation of Formulation F-2 According to the Invention

22 g (151 mmol) of adipic acid (b1-1), 8 g (69 mmol) of maleic acid (b2-3) and 2.5 g (26 mmol) of sodium propionate (b2-4) and 210 ml of distilled water were mixed with one another in a stirred vessel. 8 g of a 50% by weight aqueous sodium hydroxide solution (corresponding to 100 mmol of NaOH) were added. 240 g of a 50% by weight aqueous solution of glutaraldehyde (a-1) were then metered in with stirring. Aqueous formulation F-2 according to the invention was obtained. Aqueous formulation F-2 according to the invention had a pH of from 3 to 4.

A 50% by weight aqueous solution of glutaraldehyde, pH from 3 to 4, was used as comparative formulation V-F-3.

### II. Production of Leather

Below, data in % by weight are based on starting material (split, pelt, hide) used in the respective step, unless expressly stated otherwise. Treatment steps were effected at room temperature, unless expressly stated otherwise.

Water of 24° dH was used, unless expressly stated otherwise.

LVU: Löhlein-Volhard units, determinable, for example, by methods which are based on the degradation of casein by an enzyme to be investigated and the subsequent titration of the liberated carboxyl groups with 0.1 N NaOH. One LVU corresponds to 0.00575 ml of 0.1 N NaOH.

### II.1 Preliminary Work: Liming and Deliming

II.1.1 Liming with Subsequent Deliming with Boric Acid.

40 kg of cattle hides (South German material) were soaked and were limed with 3% by weight of lime, 1.5% by weight of sodium sulfide and 0.7% by weight of sodium hydrogen sulfide at a liquor length of 150% over 1.6 hours. Washing with water, fleshing and splitting to a split thickness of 2.5 mm were then effected. Splits were obtained and were cut into two halves per cattle.

In a rotatable drum having baffles, 100% by weight of water, 0.4% by weight of boric acid and 0.1% by weight of formic acid and 0.1% by weight of Na₂SO₃ were added to the cattle split. Drumming was effected over a period of 30 minutes. Thereafter, the liquor was discharged and 50% by weight of water, 1.0% by weight of boric acid and 0.2% by weight of formic acid and 0.1% by weight of Na₂SO₃ were added. Drumming was effected for a further 45 minutes and a further 100% by weight of water were added, and furthermore 0.5% by weight of commercially available pancreatin with 1000 LVU/g and 0.1% by weight of a surfactant (2-ethylhexanol ethoxylated with 6 equivalents of ethylene oxide). Drumming was effected for a further 30 minutes at 32° C. Thereafter, the liquor was discharged and the delimed pelts BI-1 were washed twice with 150% by weight of water each time.

II.1.2 Liming with Subsequent Deliming with Ammonium Salts

40 kg of cattle hides (South German material) were soaked and were limed with 3% by weight of lime, 1.5% by weight of sodium sulfide and 0.7% by weight of sodium hydrogen sulfide at a liquor length of 15.0% over 16 hours. Washing with water, fleshing and splitting to a split thickness of 2.5 mm were then effected. Splits were obtained and Were cut into two halves per cattle.

In a rotatable drum having baffles, 100% by weight of water, 0.35% by weight of NH₄Cl and 0.15% by weight of (NH₄)₂SO₄ and 0.1% by weight of Na₂SO₃ were added to the cattle split. Drumming was effected over a period of 30 minutes. Thereafter, the liquor was discharged and 50% by weight of water, 0.8% by weight of NH₄Cl and 0.4% by weight of (NH₄)₂SO₄ and 0.1% by weight of Na₂SO₃ were added. Drumming was effected for a further 45 minutes and a further 100% by weight of water were added, and furthermore 0.5% by weight of commercially available pancreatin with 1000 LVU/g and 0.1% by weight of a surfactant (2-ethylhexanol ethoxylated with 6 equivalents of ethylene oxide). Drumming was effected for a further 30 minutes at 32° C. Thereafter, the liquor was discharged and the delimed pelts BI-2 were washed twice with 150% by weight of water each time.

II.1.3 Liming with Subsequent Deliming with Organic Carbonates

40 kg of cattle hides (South German material) were soaked and were limed with 3% by weight of lime, 1.5% by weight of sodium sulfide and 0.7% by weight of sodium hydrogen sulfide at a liquor length of 150% over 16 hours. Washing with water, fleshing and splitting to a split thickness of 2.5 mm were then effected. Splits were obtained and were cut into two halves per cattle.

In a rotatable drum having baffles, 100% by weight of water, 0.15% by weight of ethylene carbonate and 0.15% by weight of propylene carbonate and 0.1% by weight of Na₂SO₃ were added to the cattle split. Drumming was effected over a period of 30 minutes. Thereafter, the liquor was discharged and 50% by weight of water, 0.6% by weight of ethylene carbonate and 0.6% by weight of propylene carbonate and 0.1% by weight of Na₂SO₃ were added. Drumming was effected for a further 45 minutes and a further 100% by weight of water were added, and furthermore 0.5% by weight of commercially available pancreatin with 1000 LVU/g and 0.1% by weight of a surfactant (2-ethylhexanol ethoxylated with 6 equivalents of ethylene oxide). Drumming was effected for a further 30 minutes at 32° C. Thereafter, the liquor was discharged and the delimed pelts BI-3 were washed twice with 150% by weight of water each time.

### II.2 Pickling

The pickling liquors PF-1 to PF-4 were prepared by mixing the substances according to table 1 and making up with water. The pickling liquors PF-1 to PF-4 thus obtainable had a pH of 2.8.

TABLE 1
Composition of pickling liquors PF-1 to PF-4 used

| | H₂SO₄ | HCOOH | NaCl | MgCl₂ | CaCl₂ | |
|---|---|---|---|---|---|---|
| | [g/l] | [g/l] | [° Be] | [mmol/l] | [mmol/l] | [° dH] |
| PF-1 | 15 | 8 | 7.0 | — | — | 0 |
| PF-2 | 15 | 8 | 7.0 | 0.54 | 3 | 20 |
| PF-3 | 15 | 8 | 7.0 | 1.1 | 6.1 | 40 |
| PF-4 | 15 | 8 | 7.0 | 2.7 | 15.3 | 100 |

MgCl₂ was used in the form of a hexahydrate.

The delimed pelts from BI-1 to BI-3 were each halved and were treated in separate drums over a period of 90 minutes with 150% by weight of one of the pickling liquors PF-1 to PF-4 (cf. table 2). The pickled pelts PB-1 to PB-12 were obtained. PB-1 to PB-12 were each cut in to three pieces of equal size, each having a pelt weight of 1.5 kg.

II.3 Pretanning and Tanning (General Method)

In a rotatable drum having baffles, 120% by weight of pickling liquor from 11.2 and then 3% by weight of a formulation F-1 or F-2 according to the invention (examples according to the invention) or comparative formulation V-F-3 were added to a piece of pickled pelt from 11.2. Drumming was effected for 30 minutes and then 3% by weight of sulfone tanning agent from EP-B 0 459 168, example K1, were added. Drumming was effected for a further 90 minutes and then basification was effected with a mixture (weight ratio 1:2) of sodium formate and naphthalenesulfonic acid/formaldehyde condensate, prepared according to U.S. Pat. No. 5,186,846, “Dispersant 1” example, to a pH of 4. The semifinished product thus obtainable was washed twice with water, sammed and shaved to 1.8 mm thickness. The samming behavior, the shaveability and the whiteness were assessed. Furthermore, the shrinkage temperature was determined.

The shrinkage temperatures were determined according to the method from DIN 53 336 (1977), the method having been modified as follows:
Point 4.1: The test pieces had the dimensions 3 cm·1 cm; the thickness was not determined.
Point 4.2: Only one specimen was tested per leather sample, instead of 2 specimens.
Point 6: Omitted
Point 7: The drying in a vacuum desiccator was omitted.
Point 8: The shrinkage temperature was measured when the pointer traveled back.

For assessing the finished leathers, retanning was effected by the method stated in example II.4.

The results of the testing of the performance characteristics, are shown in tables 2 and 3.

### II.4 General Method for Retanning

150% by weight of water were added to the semifinished product according to example II.3 in a rotatable drum having baffles. The following were added in each case at intervals of 15 minutes:

2% by weight of fatliquoring agent C2 from WO 03/70988,
4% by weight of a 30% by weight aqueous solution of a methacrylic acid homopolymer, partly neutralized with NaOH and having the following analytical data: Mₙ 10 000 g/mol; Fikentscher K value: 12 (determined as a 1% by weight aqueous solution), viscosity of the 30% by weight solution: 65 mPa·s (DIN EN ISO 3219, 23° C.), pH 5.1.
5% by weight of sulfone tanning agent from EP-B 0 459 168, example K1.

The following were then metered: 4% by weight of a vegetable tanning agent (quebracho), 4% by weight of melamine/formaldehyde resin (resin tanning agent), a further 2% by weight of fatliquoring agent C2 from WO 03/70988 and 2% by weight of a brown dye mixture which had the following composition:

70 parts by weight of dye from EP-B 0 970 148, example 2.18,
30 parts by weight of Acid Brown 75 (iron complex), Color Index 1.7.16.

Drumming was effected for one hour at 30° C., a pH of 3.6 was established with formic acid and a further 5.5% by weight of fatliquoring agent C2 from WO 03/70988 were added. Acidification to a pH of 3.2 was effected with formic acid and a sample of the liquor was taken.

The leathers thus obtainable were washed twice with 100% by weight of water, stored moist overnight and, after samming, were dried on a toggle frame at 50° C. The leathers L-1 to L-24 according to the invention and the comparative leathers V-L-25 to V-L-36 were obtained. After staking, the leathers were assessed as described below.

The evaluation was effected according to a rating system from 1 (very good) to 5 (poor). The evaluation of the whiteness and of the levelness was effected visually. The samming behavior was assessed in each case at identical samming pressure of 100 bar on the basis of the quality of the dewatering and the fiber structure on the flesh side (isolated fibers with slight fiber adhesion represent the ideal state). The shaveability was assessed on the basis of the levelness of the shaving result over the surface, the shavings (isolated fibers, loose structure), the morphology of the flesh side (unintended irreversible hardening can occur as a result of the temperature development) and the persistence of (troublesome) shavings on the flesh side.

The assessment of the fullness, grain tightness and softness was effected in each case in direct comparison by appropriately trained leather technicians.

TABLE 2
Leathers produced

| | | Deliming | |
|---|---|---|---|
| Leather | Formulation | (method) | Pickling liquor |
| L-1 | F-1 | II.1.1 | PF-1 |
| L-2 | F-1 | II.1.1 | PF-2 |
| L-3 | F-1 | II.1.1 | PF-3 |
| L-4 | F-1 | II.1.1 | PF-4 |
| L-5 | F-1 | II.1.2 | PF-1 |
| L-6 | F-1 | II.1.2 | PF-2 |
| L-7 | F-1 | II.1.2 | PF-3 |
| L-8 | F-1 | II.1.2 | PF-4 |
| L-9 | F-1 | II.1.3 | PF-1 |
| L-10 | F-1 | II.1.3 | PF-2 |
| L-11 | F-1 | II.1.3 | PF-3 |
| L-12 | F-1 | II.1.3 | PF-4 |
| L-13 | F-2 | II.1.1 | PF-1 |
| L-14 | F-2 | II.1.1 | PF-2 |
| L-15 | F-2 | II.1.1 | PF-3 |
| L-16 | F-2 | II.1.1 | PF-4 |
| L-17 | F-2 | II.1.2 | PF-1 |
| L-18 | F-2 | II.1.2 | PF-2 |
| L-19 | F-2 | II.1.2 | PF-3 |
| L-20 | F-2 | II.1.2 | PF-4 |
| L-21 | F-2 | II.1.3 | PF-1 |
| L-22 | F-2 | II.1.3 | PF-2 |
| L-23 | F-2 | II.1.3 | PF-3 |
| L-24 | F-2 | II.1.3 | PF-4 |
| V-L-25 | V-F-3 | II.1.1 | PF-1 |
| V-L-26 | V-F-3 | II.1.1 | PF-2 |
| V-L-27 | V-F-3 | II.1.1 | PF-3 |
| V-L-28 | V-F-3 | II.1.1 | PF-4 |
| V-L-29 | V-F-3 | II.1.2 | PF-1 |
| V-L-30 | V-F-3 | II.1.2 | PF-2 |
| V-L-31 | V-F-3 | II.1.2 | PF-3 |
| V-L-32 | V-F-3 | II.1.2 | PF-4 |
| V-L-33 | V-F-3 | II.1.3 | PF-1 |
| V-L-34 | V-F-3 | II.1.3 | PF-2 |
| V-L-35 | V-F-3 | II.1.3 | PF-3 |
| V-L-36 | V-F-3 | II.1.3 | PF-4 |

TABLE 3
Results of testing of the performance characteristics

| | Shrinkage | | Samming | Shave- | | | Grain | |
|---|---|---|---|---|---|---|---|---|
| | temperature | Whiteness of | behavior of | ability of | Levelness of | Fullness of | tightness of | Softness of |
| Leather | [° C.] | wet white | wet white | wet white | leather | leather | leather | leather |
| L-1 | 78 | 1.5 | 2 | 1 | 2 | 2.5 | 2.0 | 1.5 |
| L-2 | 76 | 1.5 | 1 | 2 | 2 | 2.5 | 2.0 | 1.5 |
| L-3 | 79 | 1.0 | 1 | 1 | 1 | 2.0 | 2.0 | 2.0 |
| L-4 | 77 | 1.5 | 1 | 1 | 2 | 2.0 | 2.0 | 1.5 |
| L-5 | 75 | 2.0 | 2 | 2 | 2 | 2.5 | 2.0 | 1.5 |
| L-6 | 76 | 1.5 | 2 | 2 | 2 | 3.0 | 2.0 | 2.5 |
| L-7 | 77 | 2.0 | 2 | 1 | 2 | 2.5 | 2.5 | 2.0 |
| L-8 | 74 | 2.0 | 2 | 2 | 2 | 3.0 | 3.0 | 2.0 |
| L-9 | 74 | 2.0 | 1 | 1 | 1 | 2.0 | 2.0 | 2.0 |
| L-10 | 75 | 1.5 | 1 | 1 | 1 | 2.5 | 2.0 | 2.5 |
| L-11 | 76 | 1.5 | 1 | 1 | 2 | 1.5 | 2.0 | 2.5 |
| L-12 | 74 | 2.5 | 2 | 2 | 1 | 2.0 | 2.5 | 2.5 |
| L-13 | 76 | 1.5 | 1 | 1 | 2 | 1.5 | 1.5 | 3.0 |
| L-14 | 73 | 1.5 | 1 | 1 | 2 | 1.0 | 1.5 | 2.0 |
| L-15 | 75 | 2.0 | 2 | 1 | 1 | 1.5 | 2.0 | 2.0 |
| L-16 | 76 | 2.0 | 2 | 2 | 1 | 2.5 | 2.0 | 2.0 |
| L-17 | 77 | 2.0 | 3 | 1 | 2 | 2.0 | 2.0 | 2.5 |
| L-18 | 75 | 2.5 | 2 | 2 | 3 | 2.0 | 2.0 | 2.5 |
| L-19 | 75 | 2.5 | 2 | 1 | 2 | 2.5 | 2.0 | 3.0 |
| L-20 | 76 | 2.0 | 2 | 2 | 2 | 2.5 | 2.5 | 2.5 |
| L-21 | 75 | 2.0 | 2 | 2 | 2 | 2.0 | 2.0 | 2.0 |
| L-22 | 74 | 2.5 | 2 | 2 | 2 | 2.0 | 1.5 | 2.0 |
| L-23 | 76 | 2.5 | 1 | 1 | 2 | 2.0 | 2.5 | 2.0 |
| L-24 | 75 | 2.0 | 1 | 2 | 2 | 2.0 | 2.5 | 2.5 |
| V-L-25 | 75 | 2.5 | 3 | 2 | 3 | 3.0 | 2.5 | 2.5 |
| V-L-26 | 73 | 2.5 | 3 | 3 | 3 | 2.5 | 2.0 | 3.0 |
| V-L-27 | 74 | 3.0 | 3 | 4 | 4 | 3.5 | 3.0 | 3.0 |
| V-L-28 | 73 | 3.0 | 4 | 4 | 4 | 3.0 | 3.0 | 3.0 |
| V-L-29 | 75 | 3.0 | 4 | 4 | 4 | 3.5 | 3.0 | 3.0 |
| V-L-30 | 74 | 4.5 | 4 | 4 | 3 | 4.0 | 3.0 | 3.5 |
| V-L-31 | 73 | 4.5 | 4 | 5 | 5 | 3.0 | 4.0 | 4.0 |
| V-L-32 | 72 | 5.0 | 4 | 5 | 5 | 3.5 | 4.0 | 4.0 |
| V-L-33 | 72 | 3.0 | 3 | 3 | 4 | 3.0 | 3.0 | 3.0 |
| V-L-34 | 73 | 4.0 | 4 | 4 | 3 | 3.0 | 3.0 | 3.0 |
| V-L-35 | 71 | 3.5 | 4 | 4 | 4 | 3.0 | 4.0 | 3.0 |
| V-L-36 | 70 | 4.0 | 3 | 5 | 4 | 4.5 | 3.5 | 4.0 |

1-14. (canceled)

15. A process for the production of leather, wherein, after liming, deliming and, if appropriate, pickling, animal hides are treated with
(a) at least one organic tanning agent; and
(b) a mixture of
(b1) at least one C₃-C₁₂-dicarboxylic acid, and
(b2) at least one further acidic compound selected from C₁-C₃-mono- and C₃-C₁₂-dicarboxylic acids, and salts thereof.

16. The process according to claim 15, wherein the organic tanning agent (a) is selected from aldehydes, dialdehydes, and compounds which can eliminate formaldehyde, acetaldehyde, or dialdehydes at acidic pH in the presence of water.

17. The process according to claim 15, wherein the organic tanning agent (a) selected is glutaraldehyde.

18. The process according to claim 15, wherein mixture (b) comprises at least two C₃-C₁₂-dicarboxylic acids selected from adipic acid, glutaric acid, maleic acid, succinic acid, and salts thereof.

19. The process according to claim 15, wherein the treatment is a pretanning or tanning.

20. The process for the production of leather according to claim 15, wherein, during the pickling, animal hides are treated with
(a) at least one organic tanning agent; and
(b) a mixture of
(b1) at least one C₃-C₁₂-dicarboxylic acid, and
(b2) at least one further acidic compound selected from C₁-C₃-mono- and C₃-C₁₂-dicarboxylic acids, and salts thereof.

21. A formulation comprising:
(a) at least one organic tanning agent selected from dialdehydes and compounds which can eliminate dialdehydes at acidic pH; and
(b) a mixture of
(b1) at least one C₃-C₁₂-dicarboxylic acid,
(b2) at least one further acidic compound selected from C₁-C₃-mono- and C₃-C₁₂-dicarboxylic acids, and salts thereof.

22. The formulation according to claim 21, wherein the organic tanning agent (a) selected is glutaraldehyde.

23. The formulation according to claim 21, wherein mixture (b) comprises at least two C₃-C₁₂-dicarboxylic acids selected from adipic acid, glutaric acid, maleic acid, succinic acid, and salts thereof.

24. A process for the production of leather using a formulation according to claim 21.

25. The process according to claim 24, wherein the formulation is used during pickling.

26. A semifinished product or leather produced by a process according to claim 15.

27. A process for the preparation of formulations according to claim 21, wherein first a mixture (b) of at least one C₃-C₁₂-dicarboxylic acid (b1) and at least one further acidic compound (b2) selected from C₁-C₃-mono- or C₃-C₁₂-dicarboxylic acids in water is prepared and, if appropriate, partly or completely neutralized and then at least one organic tanning agent (a), selected from dialdehydes and compounds which eliminate dialdehydes at acidic pH, is admixed.

28. The process according to claim 16, wherein the organic tanning agent (a) selected is glutaraldehyde.

29. The process according to claim 17, wherein mixture (b) comprises at least two C₃-C₁₂-dicarboxylic acids selected from adipic acid, glutaric acid, maleic acid, succinic acid, and salts thereof.

30. The process according to claim 18, wherein the treatment is a pretanning or tanning.

31. The formulation according to claim 22, wherein mixture (b) comprises at least two C₃-C₁₂-dicarboxylic acids selected from adipic acid, glutaric acid, maleic acid, succinic acid, and salts thereof.

32. A process for the production of leather using formulation according to claim 23.

33. The process according to claim 25, wherein the formulation is used during pickling.

34. A semifinished product or leather produced by a process according to claim 16.
